(19) United States
(12) Patent Application Publication
(10) Pub. No.: US 2003/0149132 A1
(43) Pub. Date: Aug. 7, 2003

(54) Pigment-based inkjet ink composition with decresed feathering

(75) Inventors: Yu-Chang Shen, Taipei (TW); Chia-Hsin Chien, Taoyuan (TW); Yu-Ting Lin, Lujou City (TW)

Correspondence Address: CAMPBELL & FLORES LLP, 4370 LA JOLLA VILLAGE DRIVE, 7TH FLOOR, SAN DIEGO, CA, 92122, US

(73) Assignee: BENO CORPORATION

(21) Appl. No.: 10/349,785

(22) Filed: Jan. 22, 2003

(30) Foreign Application Priority Data
Jan. 23, 2002 (TW) 91101066

(51) Int. Cl. C03C 17/00; C09D 5/00

(52) U.S. Cl. 523/160; 523/161

(57) ABSTRACT

A pigment-based ink composition for inkjet printing. The ink composition includes at least one dispersive pigment, an aqueous solution medium, and a 2-pyrrolidone compound. The ink composition of the present invention effectively controls the line width of printed images, decreases feathering, and enhances printing quality when used in inkjet printing.

### BACKGROUND OF THE INVENTION

1. Field of the Invention

The present invention relates to an inkjet ink composition, and more particularly to a pigment-based inkjet ink composition that effectively controls the line width of printed images and decreases feathering.

2. Background of the Invention

Ink-jet printing technology has been developed for many years. The advantages include low price, low noise, and good full-color printing quality. Also, various recording substrate including plain paper, paper for special printing, and transparency can be printed.

Generally, ink used for inkjet printing can be classified into dye-based ink and pigment-based ink. Dye-based ink has superior color brightness, but has poor light resistance. Moreover, dye has good water solubility; therefore, it has poor water resistance. When the printed image using dye-based ink contacts water, dye is dissolved again, thus affecting printing quality. A suitable organic compound or resin can be added to the dye-based ink to solve this problem. This enhances the interaction between the dye and recording substrate and makes the dye adhere to the substrate more effectively, thus increasing the water resistance. Pigment-based ink has better water and light resistance, but exhibits less brightness. Moreover, pigment particles disperse unevenly and easily coagulate to form larger particles, thus clogging the nozzle Therefore, good dispersion is an important requirement for a pigment-based ink .

In addition to color brightness, water resistance, and light resistance, decreasing bleeding of ink droplets and increasing printing speed also improve printing quality. When ink of one color is printed on paper, if the ink droplets can not effectively coagulate, they will, by means of capillarity action through the paper fibers, diffuse into another color. This phenomenon is called bleeding, and severely affects printing quality. An effective surfactant or organic solvent must be added to the ink to prevent bleeding of ink droplets.

Hewlett-Packard, in U.S. Pat. No. 5,108,503 discloses a dye-based ink composition including a dye and a 2-pyrrolidone compound such as 2-pyrrolidone or N-hydroxyethyl-2-pyrtolidone. The 2-pyrrolidone compound improves smear resistance.

U.S. Pat. No. 6,231,654 discloses an organic solvent-based ink composition including an organic solvent and a nitrogen-containing cyclic organic compound such as 2-pyrrolidone or N-hydroxyethyl-2-pyrrolidone. The nitrogen-containing cyclic organic compound increases the adhesion between the ink and hydrophobic recording substrate.

SUMMARY OF THE INVENTION

One object of the present invention is to provide a pigment-based inkjet ink composition that effectively controls the line width of printed images, decreases feathering, and improves printing quality.

Another object of the present invention is to provide a method for decreasing feathering when performing inkjet printing.

To achieve the above-mentioned objects, the pigment-based ink composition of the present invention includes at least one dispersive pigment, an aqueous solution medium, and a 2-pyrrolidone compound. When the ink composition is inkjet printed onto a recording substrate, feathering is decreased.

The method for decreasing feathering when preforming inkjet printing according to the present invention includes the following steps. A pigment-based ink composition is provided, and the ink composition includes at least one dispersive pigment, an aqueous solution medium, and a 2-pyrrolidone compound- Then, the ink composition is inkjet printed onto a recording substrate to decrease feathering.

### DETAILED DESCRIPTION OF THE INVENTION

The pigment-based ink composition of the present invention includes at least one pigment to provide at least one color. The pigment can be any dispersive pigment. Representative examples include AcryJet Black 357 from Rohm & Haas, Bayscipt Black VPSP 20016 from Bayer AG, Bayscipt Black VPSP 20046 from Bayer AG, Cab-O-Jet 200 from Cabot, Cab-O-Jet 300 from Cabot, BonJet CW-1 from Orient, and BonJet CW-2 from Orient. Pigment, however, has a larger particle size, which easily coagulates to form precipitaion, thus clogging the nozzle of ink cartridge. Therefore, the pigment used in the present invention preferably has a particle size of less than 1 μm, most preferably between 0.001 to 0.2 μm. Moreover, an effective dispersant and adhesive can be added to decrease clogging. The pigment can be present in an amount of 1 to 7 weight %, preferably 2.5 to 5.5 weight %, based on the total weight of the ink composition.

The ink composition of the present invention is aqueous solution-based and includes an aqueous solution medium.

Water is the main solvent and is present in an amount of 50 to 95 weight %, preferably 70 to 90 weight %, based on the total weight of the ink composition. In addition to water, the aqueous solution medium can further include at least one water-soluble or water-miscible organic solvent and inorganic salt, in order to enhance ink permeation and dispersion. The organic solvent can be present in an amount of not higher than 30 weight %, preferably 0.01 to 30 weight %, most preferably 5 to 15 weight %. Suitable organic solvent includes but is not limited to methanol, ethanol, ethylene glycol, diethylene glycol, triethylene glycol, polyethylene glycol, propylene glycol, butylenes glycol, pentylene glycol, 2-propanol, di-1,2-propylene glycol, 2-pyrrolidone, N-methyl-2-pyrrolidone, 2,4,7,9-tetramethyl-5-decyne-4,7-diol, 1,1,1-trimethylolpropane, polyethylene glycol, polypropene glycol, EO/PO copolymer, BO/EO copolymer, hexylene glycol, and polyols.

The key additive of the ink composition of the present invention is a 2-pyrrolidone compound. 2-pyrrolidone compounds suitable for use in the present invention include but are not limited to 2-pyrrolidone, N-(C₁₋₄)alkyl-2-pyrrolidone, N-(C₂₋₄)alkenyl-2-pyrrolidone, and N-(C₁₋₄)hydroxyalkyl-2-pyrrolidone. One or more 2-pyrrolidone compounds can be added to the ink composition of the present invention. The addition amount depends on the solubility of the 2-pyrrolidone and can be in the range of 0.01 to 25 weight %, preferably 1 to 15 weight %. The present invention finds that by means of adding the 2-pyrrolidone compound, the line width of printed images is effectively controlled and feathering is decreased when performing inkjet printing. Thus, printing quality is enhanced.

The ink composition of the present invention can further include one or more surfactants added in an amount of 0.01 to 15 weight %, preferably 0.01 to 3 weight %. By means of adding a suitable amount of surfactant, the ink composition has suitable viscosity, thus making ink-delivery and ink-ejection more smooth. Moreover, suitable surface tension $ inhibits bleeding and enhances the additive's dispersion in the ink and the ink's permeation to the recording substrate. Surfactant suitable for use in the present invention can be anionic, cationic, non-ionic, or amphoteric. Representative examples include sodium dioctyl sulfosuccinate, alkylene oxide adduct of acetylene glycol, polybutyl resin, cellulose derivative, styrene/acrylic copolymer resin, maleic acid/ styrene copolymer, and a polymer containing both hydrophilic segments and hydrophobic segments. Commercially available surfactants include Tergitol 15-S-9 from Union Carbide, A-102 from CYTEC, LF-4 from CYTEC, EP-810 from AIR PRODUCT, CT-141 from AIR PRODUCT, CT-151 from AIR PRODUCT, OT-75 from CYTEC, GPG from CYTEC, and OT-70PG from CYTEC.

The ink composition of the present invention can further include a humectant. Ink cartridge nozzle is exposed to atmosphere environment for a long term. Ink at the nozzle easily evaporates and forms precipitation, thus in turn clogging the nozzle and affecting printing quality. Therefore, in order to slow down the evaporation rate of ink at the nozzle and prevent clogging, a humectant is generally added to an ink composition. The humectant suitable for use in the present invention can be a water-soluble organic compound that not easily evaporates, such as ethylene glycol, polyethylene glycol, and glycerol. The addition amount can be 0.1 to 20 weight %, preferably 2 to 15 weight %.

The ink composition of the present invention can further include a pH buffer solution, since the colorant can create ideal colors only within a suitable pH range. The pH buffer solution suitable for use can be diethanolamine, triethanolamine, hydroxides of alkali metal such as lithium hydroxide, sodium hydroxide, and potassium hydroxide, ammonium hydroxide, and carbonates of alkali metals such as lithium carbonate, sodium carbonate, and potassium carbonates.

The ink composition of the present invention can further include a chelating agent. The addition of the chelating agent can prevent generation of crystalline salts. This prevents coagulation of particles and clogging of the nozzle. Chelating agents suitable for use include sodium ethylenediaminetetraacetate, trisodium nitrilotriacetate, hydroxyethyl ethylenediamine trisodium acetate, diethylenetriamino pentasodium acetate, and uramil disodium acetate.

In addition, the ink composition of the present invention can further include a UV-blocker to block the absorbance of UV light and thus increase the light resistance of the colorant. A biocide or preservative can be added to inhibit the growth of microorganisms.

The following examples are intended to illustrate the process and the advantages of the present invention more fully without limiting its scope, since numerous modifications and variations will be apparent to those skilled in the art.

### EXAMPLE 1

An ink composition was prepared by mixing the components shown in the following table.

| | | Addition |
|---|---|---|
| | | amount |
| Component | Compound | (weight %) |
| Dispersive | AcryJet Black 357 from Rohm & Haas | 7 |
| pigment | | |
| Humectant | Glycerin from Adrich | 6 |
| Organic | Ethylene Glycol mono-butyl ether | 1.5 |
| solvent | from Adrich | |
| Polymer | Polyethylene Glycol 900 from | 6 |
| organic | Adrich | |
| solvent | | |
| 2-pyrrolidone | 2-pyrrolidone from Adrich | 2.5 |
| compound | | |
| Biocide | Mergal K7 from Clariant | 0.5 |
| Solvent | Deionized water | 76.5 |

### EXAMPLE 2

An ink composition was prepared by mixing the components shown in the following table.

| | | Addition |
|---|---|---|
| | | amount |
| Component | Compound | (weight %) |
| Dispersive | AcryJet Black 357 from Rohm & Haas | 7 |
| pigment | | |
| Humectant | Glycerin from Adrich | 6 |
| Organic | Ethylene Glycol mono-butyl ether | 1.5 |
| solvent | from Adrich | |
| Polymer | Polyethylene Glycol 900 from | 6 |
| organic | Adrich | |
| solvent | | |
| 2-pyrrolidone | 1.5% of 2-pyrrolidone from Adrich | 2.5 |
| compound | 1% of N-methyl-2-pyrrolidone from | |
| | Adrich | |
| Biocide | Mergal K7 from Clariant | 0.5 |
| Solvent | Deionized water | 76.5 |

### EXAMPLE 3

An ink composition was prepared by mixing the components shown in the following table.

| | | Addition |
|---|---|---|
| | | amount |
| Component | Compound | (weight %) |
| Dispersive | AcryJet Black 357 from Rohm & Haas | 7 |
| pigment | | |
| Humectant | Glycerin from Adrich | 6 |
| Organic | Ethylene Glycol mono-butyl ether | 1.5 |
| solvent | from Adrich | |
| Polymer | Polyethylene Glycol 900 from | 6 |
| organic | Adrich | |
| solvent | | |
| 2-pyrrolidone | N-methyl-2-pyrrolidone from | 2.5 |
| compound | Adrich | |
| Biocide | Mergal K7 from Clariant | 0.5 |
| Solvent | Deionized water | 76.5 |

### EXAMPLE 4

An ink composition was prepared by mixing the components shown in the following table.

| | | Addition |
|---|---|---|
| | | amount |
| Component | Compound | (weight %) |
| Dispersive | AcryJet Black 357 from Rohm & Haas | 7 |
| pigment | | |
| Humectant | Glycerin from Adrich | 6 |
| Organic | Ethylene Glycol mono-butyl ether | 1.5 |
| solvent | from Adrich | |
| Polymer | Polyethylene Glycol 900 from Adrich | 6 |
| organic | | |
| solvent | | |
| 2-pyrrolidone | N-ethylene-2-pyrrolidone from | 2.5 |
| compound | Adrich | |
| Biocide | Mergal K7 from Clariant | 0.5 |
| Solvent | Deionized water | 76.5 |

### EXAMPLE 5

An ink composition was prepared by mixing the components shown in the following table.

| | | Addition |
|---|---|---|
| | | amount |
| Component | Compound | (weight %) |
| Dispersive | AcryJet Black 357 from Rohm & Haas | 7 |
| pigment | | |
| Humectant | Glycerin from Adrich | 6 |
| Organic | Ethylene Glycol mono-butyl ether | 1.5 |
| solvent | from Adrich | |
| Polymer | Polyethylene Glycol 900 from Adrich | 6 |
| organic | | |
| solvent | | |
| 2-pyrrolidone | N-hydroxyethyl-2-pyrrolidone from | 2.5 |
| compound | Adrich | |
| Biocide | Mergal K7 from Clariant | 0.5 |
| Solvent | Deionized water | 76.5 |

### COMPARATIVE EXAMPLE

An ink composition was prepared by mixing the components shown in the following table.

| | | Addition |
|---|---|---|
| | | amount |
| Component | Compound | (weight %) |
| Dispersive | AcryJet Black 357 from Rohm & Haas | 7 |
| pigment | | |
| Humectant | Glycerin from Adrich | 6 |
| Organic | Ethylene Glycol mono-butyl ether | 1.5 |
| solvent | from Adrich | |
| Polymer | Polyethylene Glycol 900 from Adrich | 6 |
| organic | | |
| solvent | | |
| 2-pyrrolidone | None | 0 |
| compound | | |
| Biocide | Mergal K7 from Clariant | 0.5 |
| Solvent | Deionized water | 79 |

In the ink composition of Example 3, the 2-pyrrolidone added is 2. 5 weight % of N-methyl-2-pyrrolidone, and the other components and addition amounts were the same as in Example 1. In the ink composition of Example 4, the 2-pyrrolidone added is 2.5 weight % of N-ethylene-2-pyrrolidone, and the other components and addition amounts were the same as in Example 1. In the ink composition of Example 5, the 2-pyrrolidone added is 2.5 weight % of N-hydroxyethyl-2-pyrrolidone, and the other components and addition amounts were the same as in Example 1.

Each of the above ink compositions was printed onto a commercially available plain paper in a commercially available inkjet printer. Printing quality was determined by feathering on the edges of printed image. The results are shown in the following table It can be seen from the table that the 2-pyrrolidone compound effectively controls the line width of printed images, decreases feathering and increases printing quality.

| | | Printing |
|---|---|---|
| | 2-pyrrolidone compound | quality |
| Comparative | None | X |
| Example | | |
| Example 1 | 2-pyrrolidone | ◯ |
| Example 2 | 2-pyrrolidone + | ⊙ |
| | N-methyl-2-pyrrolidone | |
| Example 3 | N-methyl-2-pyrrolidone | ⊙ |
| Example 4 | N-ethylene-2-pyrrolidone | ◯ |
| Example 5 | N-hydroxyethyl-2-pyrrolidone | ◯ |

Note:
⊙: excellent
◯: good
X: inferior

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A pigment-based ink composition suitable for inkjet printing, comprising:
at least one dispersive pigment;
an aqueous solution medium; and
a 2-pyrrolidone compound,
whereby when the ink composition is inkjet printed onto a recording substrate, feathering is decreased.

2. The pigment-based ink composition as claimed in claim 1, wherein the dispersive pigment has an average particle size less than 1 μm.

3. The pigment-based ink composition as claimed in claim 2, wherein the dispersive pigment has an average particle size of 0.001 to 0.2 μm.

4. The pigment-based ink composition as claimed in claim 1, wherein the 2-pyrrolidone compound comprises at least one of 2-pyrrolidone, N-(C₁₋₄)alkyl-2-pyrrolidone, N-(C₂₋₄)alkenyl-2-pyrrolidone, and N-(C₁₋₄)hydroxyalkyl-2-pyrrolidone.

5. The pigment-based ink composition as claimed in claim 1, wherein the 2-pyrrolidone compound is present in an amount of 0.01 to 25 weight %.

6. The pigment-based ink composition as claimed in claim 1, further comprising an organic solvent in an amount of 0.01 to 30 weight %.

7. The pigment-based ink composition as claimed in claim 1, further comprising a humectant.

8. The pigment-based ink composition as claimed in claim 1, further comprising an additive, wherein the additive is a surfactant, pH buffer solution, chelating agent, biocide, preservative, or UV-blocker.

9. A pigment-based ink composition suitable for inkjet printing, comprising:
at least one dispersive pigment;
an aqueous solution medium;
a 2-pyrrolidone compound;
an organic solvent;
a humectant; and
at least one additive, wherein the additive is a surfactant, pH buffer solution, chelating agent, biocide, preservative, or UV-blocker.

10. The pigment-based ink composition as claimed in claim 9, wherein the dispersive pigment has an average particle size less than 1 μm.

11. The pigment-based ink composition as claimed in claim 10, wherein the dispersive pigment has an average particle size of 0.001 to 0.2 μm.

12. The pigment-based ink composition as claimed in claim 9, wherein the 2-pyrrolidone compound comprises at least one of 2-pyrrolidone, N-(C₁₋₄)alkyl-2-pyrrolidone, N-(C₂₋₄)alkenyl-2-pyrrolidone, and N-(C₁₋₄)hydroxyalkyl-2-pyrrolidone.

13. The pigment-based ink composition as claimed in claim 9, wherein the 2-pyrrolidone compound is present in an amount of 0.01 to 25 weight %.

14. The pigment-based ink composition as claimed in claim 9, wherein the organic solvent is present in an amount of 0.01 to 30 weight %.

15. A method for decreasing feathering when preforming inkjet printing, comprising the following steps:
(a) providing a pigment-based ink composition including at least one dispersive pigment, an aqueous solution medium, and a 2-pyrrolidone compound; and
(b) inkjet printing the ink composition onto a recording 7 substrate to decrease feathering.

16. The method as claimed in claim 15, wherein the dispersive pigment has an average particle size less than 1 μm.

17. The method as claimed in claim 16, wherein the dispersive pigment has an average particle size of 0.001 to 0.2 μm.

18. The method as claimed in claim 15, wherein the 2-pyrrolidone compound comprises at least one of 2-pyrrolidone, N-(C₁₋₄)alkyl-2-pyrrolidone, N-(C₂₋₄)alkenyl-2-pyrrolidone, and N-(C₁₋₄)hydroxyalkyl-2-pyrrolidone.

19. The method as claimed in claim 15, wherein the 2-pyrrolidone compound is present in an amount of 0.01 to 25 weight %.

20. The method as claimed in claim 15, wherein the pigment-based ink composition further includes an organic solvent in an amount of 0.01 to 30 weight %.

21. The method as claimed in claim 15, wherein the pigment-based ink composition further includes a humectant.

22. The method as claimed in claim 15, wherein the pigment-based ink composition further includes an additive, wherein the additive is a surfactant, pH buffer solution, chelating agent, biocide, preservative, or UV-blocker.
